(19) United States
(12) Patent Application Publication
(10) Pub. No.: US 2021/0333369 A1
(43) Pub. Date: Oct. 28, 2021

(54) RANGING SYSTEM AND MOBILE PLATFORM

(71) Applicant: SZ DJI TECHNOLOGY CO., LTD., Shenzhen (CN)

(72) Inventors: Shuai DONG, Shenzhen (CN); Xiaoping HONG, Shenzhen (CN); Xiang LIU, Shenzhen (CN); Yue YAN, Shenzhen (CN); Xiaoyi GUI, Shenzhen (CN)

(21) Appl. No.: 17/371,876

(22) Filed: Jul. 9, 2021

Related U.S. Application Data
(63) Continuation of application No. PCT/CN2019/071233, filed on Jan. 10, 2019.

(51) Int. Cl. G01S 7/481; G01S 17/08; G01S 17/894; G01S 7/48

(52) U.S. Cl. CPC G01S 7/4817; G01S 7/4808; G01S 17/894; G01S 17/08

(57) ABSTRACT

A ranging system includes at least two types of a first-type ranging apparatus, a second-type ranging apparatus, and a third-type ranging apparatus. Each of the first-type ranging apparatus and the second-type ranging apparatus includes a ranging device and a scanner. The ranging device includes a light source, a convergent lens, and a receiver. The third-type ranging apparatus includes a ranging device and a scanner. A FOV of the second-type ranging apparatus is smaller than a FOV of the first-type ranging apparatus. A diameter and a focal length of a convergent lens of the second-type ranging apparatus are greater than a diameter and a focal length of a convergent lens of the first-type ranging apparatus, respectively.

### CROSS-REFERENCE TO RELATED APPLICATION

This application is a continuation of International Application No. PCT/CN2019/071233, filed Jan. 10, 2019, the entire content of which is incorporated herein by reference.

### TECHNICAL FIELD

The present disclosure generally relates to the autonomous drive field and, more particularly, to a ranging system and a mobile platform.

### BACKGROUND

An autonomous vehicle can realize 360° perception of a surrounding environment through a plurality of sensors to perform autonomous navigation to lead a passenger to arrive at a destination. Currently, many companies, such as Google, Tesla, etc., are developing their autonomous driving system. Selection and position design of different types of sensors can have a great impact on modules for multi-sensor calibration, environment perception, control decision-making, etc. in the autonomous driving system. A great autonomous driving sensor system should be able to (1) realize 360° perception of the surrounding environment without a dead-end, (2) provide reliable and stable environmental perception data with less redundancy, and (3) perform sensor calibration conveniently and quickly, and meet a requirement of real-time calibration result verification.

Different sensors have their advantages and weaknesses, such as a visible light camera can detect various vehicles and pedestrians, but the false detection probability is larger when light is too strong or too dark. A LIDAR cannot provide color information, but can provide stable ranging information, which is important for environment perception and autonomous obstacle avoidance. It is desired to solve the problem of configuring the LIDAR to realize the 360° perception of the surrounding environment to provide stable and reliable data for the calibration module and the positioning and navigation module in the autonomous drive technology.

### SUMMARY

Embodiments of the present disclosure provide a ranging system including at least two types of a first-type ranging apparatus, a second-type ranging apparatus, and a third-type ranging apparatus. Each of the first-type ranging apparatus and the second-type ranging apparatus includes a ranging device and a scanner. The ranging device includes a light source, a convergent lens, and a receiver. The light source is configured to emit a light pulse sequence. The convergent lens is configured to converge a portion of light pulse reflected by an object to the receiver. The receiver is configured to determine a distance of an object according to the portion of a light pulse. The scanner is configured to change an emission direction of the light pulse sequence emitted by the light source to scan in a FOV (FOV) and includes two rotation light refraction elements. Each of the two rotation light refraction elements includes a light emission surface and a light incident surface that are opposite and not parallel to each other. The third-type ranging apparatus includes a ranging device and a scanner. The ranging device includes a light source that is configured to emit a light pulse sequence. The scanner is configured to change an emission direction of the light pulse sequence emitted by the light source to scan in a FOV and includes three rotation light refraction elements. Each of the three rotation light refraction elements includes a light emission surface and a light incident surface that are opposite and parallel to each other. A FOV of the second-type ranging apparatus is smaller than a FOV of the first-type ranging apparatus. A diameter and a focal length of a convergent lens of the second-type ranging apparatus are greater than a diameter and a focal length of a convergent lens of the first-type ranging apparatus, respectively.

### BRIEF DESCRIPTION OF THE DRAWINGS

FIG. 1 is a schematic architectural diagram of a ranging apparatus according to some embodiments of the present disclosure.

FIG. 2 is a schematic diagram of a ranging apparatus according to some embodiments of the present disclosure.

FIG. 3 is a schematic diagram showing a scan FOV of a first-type ranging apparatus according to some embodiments of the present disclosure.

FIG. 4 is a schematic diagram showing a scan FOV of a second-type ranging apparatus according to some embodiments of the present disclosure.

FIG. 5 is a schematic diagram showing a scan FOV of a third-type ranging apparatus according to some embodiments of the present disclosure.

FIG. 6 is a schematic diagram showing a scan FOV of a fourth-type ranging apparatus according to some embodiments of the present disclosure.

FIG. 7 is a schematic diagram showing a ranging system including a plurality of ranging apparatuses according to some embodiments of the present disclosure.

FIG. 8 is a schematic diagram showing a ranging system including a plurality of ranging apparatuses according to some embodiments of the present disclosure.

FIG. 9 is a schematic diagram showing a ranging system including a plurality of ranging apparatuses according to some embodiments of the present disclosure.

FIG. 10 is a schematic diagram showing a ranging system including a plurality of ranging apparatuses according to some embodiments of the present disclosure.

FIG. 11 is a schematic diagram showing a ranging system including a plurality of ranging apparatuses according to some embodiments of the present disclosure.

FIG. 12 is a schematic diagram showing a ranging system including a plurality of ranging apparatuses according to some embodiments of the present disclosure.

FIG. 13 is a schematic diagram showing a ranging system including a plurality of ranging apparatuses according to some embodiments of the present disclosure.

FIG. 14 is a schematic diagram showing a ranging system including a plurality of ranging apparatuses according to some embodiments of the present disclosure.

FIG. 15 is a schematic diagram showing a ranging system including a plurality of ranging apparatuses according to some embodiments of the present disclosure.

FIG. 16 is a schematic diagram showing a ranging system including a plurality of ranging apparatuses according to some embodiments of the present disclosure.

### DETAILED DESCRIPTION OF THE EMBODIMENTS

To make purposes, technical solutions, and advantages of the present disclosure clearer, embodiments of the present disclosure are described in conjunction with the accompanying drawings below. The described embodiments are only some embodiments not all the embodiments of the present disclosure. The present disclosure is not limited by embodiments described here. Based on the embodiments of the disclosure, all other embodiments obtained by those of ordinary skill in the art without any creative work are within the scope of the present disclosure.

In the following description, a lot of specific details are given to provide a more thorough understanding of the present disclosure. However, it is obvious to those skilled in the art that the present disclosure can be implemented without one or more of these details. In other examples, to avoid confusion with the present disclosure, some technical features known in the art are not described.

The present disclosure may be implemented in different forms and should not be understood to be limited by the described embodiments. On contrary, providing these embodiments will cause the present disclosure to be thorough and complete, and will fully convey the scope of the present disclosure to those skilled in the art.

Terms used in the present disclosure describe merely specific embodiments but are not intended to limit the present disclosure. The singular forms of “a,” “one,” and “said/the” used in the present disclosure and the appended claims are also intended to include plural forms unless the context indicates other meanings. When the terms “including” and/or “containing” are used in the specification, the existence of the described features, integers, steps, operations, elements, and/or components is determined, but do not exclude the existence or addition of one or more other features, integers, steps, operations, elements, and/or components. As used herein, the term “and/or” includes any and all combinations of related listed items.

To understand the present disclosure, a detailed structure is described below to explain the technical solution of the present disclosure. Some embodiments of the present disclosure are described in detail below. However, except these embodiments, the present disclosure may include other embodiments.

The present disclosure provides a ranging system. The ranging system may include at least two types of a first-type ranging apparatus, a second-type ranging apparatus, and a third-type ranging apparatus.

Each of the first-type ranging apparatus and the second ranging apparatus may include a ranging device and a scanner. The ranging device may include a light source configured to emit a light pulse sequence. The scanner may include two rotation light refraction elements. A light refraction element may include a light emission surface and a light incident surface that are opposite and not parallel to each other. The scanner may be configured to change an emission direction of the light pulse sequence emitted by the light source to scan in a field of view (FOV). The ranging device may further include a convergent lens and a receiver. The convergent lens may be configured to converge at least a portion of a light pulse reflected by an object to the receiver. The receiver may be configured to determine the distance of the object according to the at least the portion of the light pulse.

A FOV of the second-type ranging apparatus may be smaller than a FOV of the first-type ranging apparatus. A diameter and a focal length of a convergent lens in the second-type ranging apparatus may be greater than a diameter and a focal length of a convergent lens in the first-type ranging apparatus.

The third-type ranging apparatus may include a ranging device and a scanner. The ranging device may include a light source configured to emit a light pulse sequence. The scanner may include three rotation light refraction elements. Each of the three light refraction elements may include a light emission surface and a light incident surface that are opposite and parallel to each other. The scanner may be configured to change a transmission direction of the light pulse sequence emitted by the light source to scan in a FOV.

In connection with the accompanying drawings, examples are described for the ranging apparatus of the present disclosure. When there is no conflict, embodiments and features of embodiments may be combined with each other.

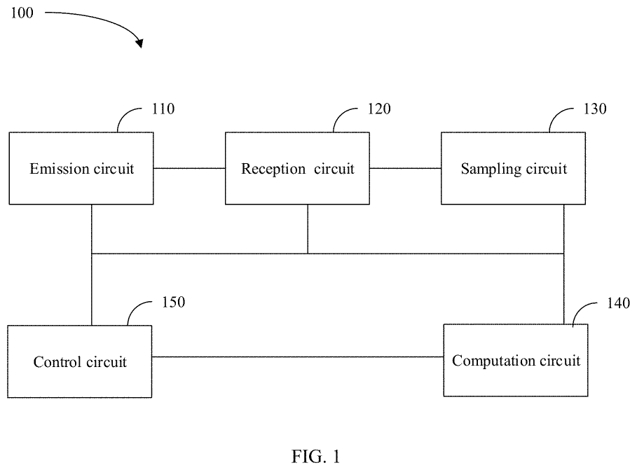

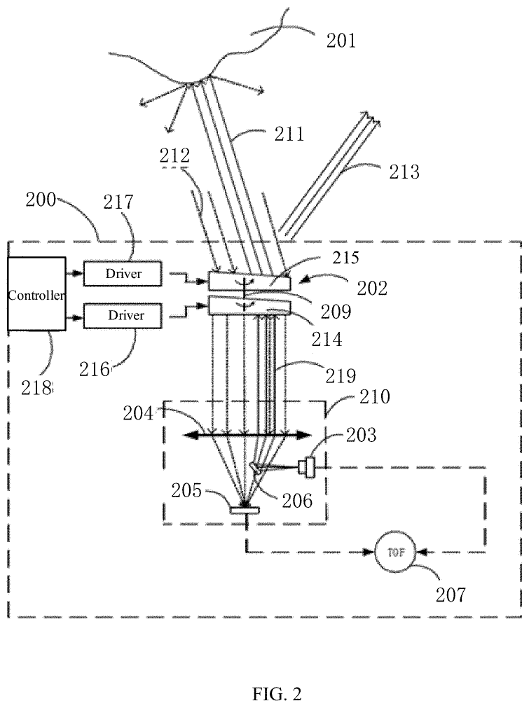

First, with reference to FIG. 1 and FIG. 2, a structure of a ranging apparatus of embodiments of the present disclosure is exemplarily described in detail. The ranging apparatus includes a LIDAR. The ranging apparatus may be merely used as an example. Another suitable ranging apparatus may also be applied in the present disclosure.

The ranging apparatus may include an electronic apparatus such as a LIDAR, a laser ranging apparatus, etc. In some embodiments, the ranging apparatus may be configured to sense external environment information, for example, distance information of an environment target, orientation information, reflection density information, speed information, etc. In some embodiments, the ranging apparatus may be configured to detect a distance from a detected object to the ranging apparatus by measuring light transmission time, i.e., time-of-flight (TOF), between the ranging apparatus and the detected object. In some other embodiments, the ranging apparatus may be configured to detect the distance from the detected object to the ranging apparatus through another technology, for example, a ranging method based on phase shift measurement or frequency shift measurement, which is not limited here.

To facilitate understanding, an operation process for ranging is described as an example in connection with the ranging apparatus 100 shown in FIG. 1.

The ranging apparatus includes an emission device, a reception device, and a temperature control system. The emission device may be configured to emit the light pulse. The reception device may be configured to receive at least a portion of the light pulse reflected by the object and determine a distance of the object to the ranging apparatus according to the received at least the portion of the light pulse.

In some embodiments, as shown in FIG. 1, the emission device includes an emission circuit 110. The reception device includes a reception circuit 120, a sampling circuit 130, and a computation circuit 140.

The emission circuit 110 may be configured to emit a light pulse sequence (e.g., a laser pulse sequence). The reception circuit 120 may be configured to receive the light pulse sequence reflected by the detected object, perform photoelectric conversion on the light pulse sequence to obtain an electrical signal, and output the processed electrical signal to the sampling circuit 130. The sampling circuit 130 may be configured to perform sampling on the electrical signal to obtain a sampling result. The computation circuit 140 may be configured to determine the distance between the ranging apparatus 100 and the detected object based on the sampling result of the sampling circuit 130.

In some embodiments, the ranging apparatus 100 further includes a control circuit 150. The control circuit 150 may be configured to control another module or circuit. For example, the control circuit 150 may be configured to control the operation time of the modules and circuits and/or perform parameter settings on the modules and the circuits.

Although the ranging apparatus shown in FIG. 1 includes the emission circuit, the reception circuit, the sampling circuit, and the computation circuit and is configured to emit a beam for detection, the present disclosure is not limited to this. A quantity of any one circuit of the emission circuit, the reception circuit, the sampling circuit, and the computation circuit may be at least two. The ranging apparatus may be configured to emit at least two beams along a same direction or different directions. The at least two beams may be emitted simultaneously or at different times. In some embodiments, light-emitting chips of the at least two emission circuits may be packaged in a same module. For example, each emission circuit may include a laser emission chip. Dies of the laser emission chips of the at least two emitters may be packaged together and accommodated in a same package space.

In some embodiments, in addition to the structure shown in FIG. 1, the ranging apparatus 100 further includes a scanner, which may be configured to change the transmission direction of the at least one light pulse sequence emitted by the emission circuit for transmission.

A module that includes the emission circuit 110, the reception circuit 120, the sampling circuit 130, and the computation circuit 140, or a module that includes the emission circuit 110, the reception circuit 120, the sampling circuit 130, the computation circuit 140, and the control circuit 150 may be referred to as a ranging device. The ranging device may be independent of another module, for example, a scanner.

In some embodiments, a co-axial optical path may be used in the ranging apparatus. That is, the beam emitted from the ranging apparatus and a beam reflected may share at least a part of the optical path in the ranging apparatus. For example, the at least one beam of the light pulse sequence emitted by the emission circuit may be emitted after the transmission direction of the at least one beam of the light pulse sequence is changed by the scanner. The light pulse sequence reflected by the detected object may enter into the reception circuit through the scanner. In some other embodiments, off-axial optical paths may be used in the ranging apparatus. That is, the beam emitted by the ranging apparatus and the beam reflected may be transmitted along different paths in the ranging apparatus. FIG. 2 is a schematic diagram of a ranging apparatus 200 using a coaxial optical path according to some embodiments of the present disclosure.

The ranging apparatus 200 includes a ranging device 210. The ranging device 210 includes an emitter 203 (including the emission circuit), a collimation element 204, a detector 205 (including the reception circuit, the sampling circuit, and the computation circuit), and an optical path change element 206. The ranging device 210 may be configured to emit a beam, receive a returned beam, and convert the returned beam into an electrical signal. The emitter 203 may be configured to emit an optical pulse sequence. In some embodiments, the emitter 203 may emit a light pulse sequence. In some embodiments, the laser beam emitted by the emitter 203 may include a narrow bandwidth beam with a wavelength outside of a visible light range. The collimation element 204 may be arranged on an emission path of the emitter 203 and further configured to collimate the beam emitted from the emitter 203 into parallel light to emit to the scanner. The collimation element 204 may be further configured to converge at least a part of the returned beam reflected by the detected object. The collimation element 204 may include a collimation lens or another element that can collimate the beam.

In some embodiments shown in FIG. 2, an emission optical path and a reception optical path of the ranging apparatus may be combined through the optical path change element 206 before the collimation element 204. Thus, the emission optical path and the reception optical path may share the same collimation element to cause the optical path to be more compact. In some other embodiments, each of the emitter 203 and the detector 205 may include a collimation element 204. The optical path change element 206 may be arranged at the optical path after the collimation element 204.

In some embodiments shown in FIG. 2, since a diameter of a beam hole of the emitter 203 for emitting the beam is relatively small, and a diameter of a beam hole of the ranging apparatus for receiving the returned beam is relatively large, the optical path change element may use a reflection mirror with a small area to combine the emission optical path and the reception optical path. In some other embodiments, the optical path change element may also include a reflection mirror with a through-hole. The through-hole may be configured to transmit the emitted beam of the emitter 203. The reflection mirror may be configured to reflect the returned beam to the detector 205. As such, when a small reflection mirror is used, shielding of the returned beam by the holder of the small reflection mirror may be reduced.

In some embodiments shown in FIG. 2, the optical path change element 206 may be off the optical path of the collimation element 204. In some other embodiments, the optical path change element 206 may be located on the optical path of the collimation element 204.

The ranging apparatus 200 further includes a scanner 202. The scanner 202 is arranged at the emission optical path of the ranging device 210. The scanner 202 may be configured to change a transmission direction of a collimated beam 219 emitted through the collimation element 204 and project to an external environment, and project the returned beam to the collimation element 204. The returned beam may be converged at the detector 205 through the collimation element 204.

In some embodiments, the scanner 202 may include at least one optical element, which may be configured to change the transmission direction of the beam. The optical element may be configured to change the transmission direction of the beam by performing reflection, refraction, and diffraction on the beam. For example, the scanner 202 may include a lens, a reflection mirror, a prism, a galvanometer, a grating, a liquid crystal, an optical phased array, or any combination thereof. In some embodiments, at least a part of the optical elements may be movable. For example, at least a part of the optical elements may be driven to move by a driver. The movable optical elements may reflect, refract, and diffract the beam to different directions at different times. In some embodiments, a plurality of optical elements of the scanner 202 may rotate or vibrate around a shared axis 209. Each rotating or vibrating optical element may be configured to continuously change a transmission direction of an incident beam. In some embodiments, the plurality of optical elements of the scanner 202 may rotate at different rotation speeds or vibrate at different speeds. In some other embodiments, at least the part of the optical elements of the scanner 202 may rotate at a nearly same rotation speed. In some other embodiments, the plurality of optical elements of the scanner may rotate around different rotation axes. In some other embodiments, the plurality of optical elements of the scanner may rotate in a same direction or in different directions, or vibrate in a same direction or different directions, which is not limited here.

In some embodiments, the scanner 202 includes a first optical element 214 and a driver 216 connected to the first optical element 214. The driver 216 may be configured to drive the first optical element 214 to rotate around the rotation axis 209 to cause the first optical element 214 to change the direction of the collimated beam 219. The first optical element 214 may project the collimated beam 219 in different directions. In some embodiments, an included angle between the direction of the collimated beam 219 after the first optical element and the rotation axis 209 may change as the first optical element 214 rotates. In some embodiments, the first optical element 214 includes a pair of opposite surfaces that are not parallel. The collimated beam 219 may pass through the pair of surfaces. In some embodiments, the first optical element 214 may include at least a lens, whose thickness changes along a radial direction. In some embodiments, the first optical element 214 may include a wedge prism, which may be configured to refract the collimated beam 219.

In some embodiments, the scanner 202 further includes a second optical element 215. The second optical element 215 may rotate around the rotation axis 209. The second optical element 215 and the first optical element 214 may have different rotation speeds. The second optical element 215 may be configured to change the direction of the beam projected by the first optical element 214. In some embodiments, the second optical element 215 may be connected to another driver 217. The driver 217 may be configured to drive the second optical element 215 to rotate. The first optical element 214 and the second optical element 215 may be driven by the same driver or different drivers to cause the rotation speeds and/or the rotation directions of the first optical element 214 and the second optical element 215 to be different. Thus, the collimated beam 219 may be projected to different directions of external space to scan a relatively large space area. In some embodiments, a controller 218 may be configured to control the drivers 216 and 217 to drive the first optical element 214 and the second optical element 215, respectively. The rotation speeds of the first optical element 214 and the second optical element 215 may be determined according to an expected scan area and style in practical applications. The drivers 216 and 217 may include motors or other drivers.

In some embodiments, the second optical element 215 may include a pair of opposite surfaces that are not parallel. The beam may pass through the pair of surfaces. In some embodiments, the second optical element 215 may include at least a lens whose thickness changes along a radial direction. In some embodiments, the second optical element 215 may include a wedge prism.

In some embodiments, the scanner 202 may further include a third optical element (not shown in the figure) and a driver for driving the third optical element. In some embodiments, the third optical element may include a pair of opposite surfaces that are not parallel. The beam may pass through the pair of surfaces. In some embodiments, the third optical element may include at least a lens whose thickness changes along a radial direction. In some embodiments, the third optical element may include a wedge prism. At least two of the first optical element, the second optical element, and the third optical element may rotate at different rotation speeds and/or in different directions.

The optical elements of the scanner 202 may rotate to project a beam to different directions, for example, directions 213 of the projected beam 211. As such, the scanner 202 may scan the space around the ranging apparatus 200. When the projected beam 211 of the scanner 202 encounters the detected object 201, a part of the beam may be reflected by the detected object 201 along an opposite direction to the direction of the projected beam 211 to the ranging apparatus 200. The returned beam 212 reflected by the detected object 201 may be incident to the collimation element 204 after passing through the scanner 202.

The detector 205 and the emitter 203 may be arranged at a same side of the collimation element 204. The detector 205 may be configured to convert at least the part of the returned beam that passes through the collimation element 204 into an electrical signal.

In some embodiments, the optical elements may be coated with an anti-reflection film. In some embodiments, the thickness of the anti-reflection film may be equal to or close to a wavelength of the beam emitted by the emitter 203. The anti-reflection film may increase the density of the transmitted beam.

In some embodiments, a filter layer may be coated on a surface of an element of the ranging apparatus in the transmission path of the beam, or a filter may be arranged in the transmission path of the beam, which may be configured to transmit the light with a wavelength within the wavelength band of the beam emitted by the emitter and reflect the light of another wavelength band. Thus, the noise caused by environmental light may be reduced for the receiver.

In some embodiments, the emitter 203 may include a laser diode. The light pulse in the nano-second level may be emitted by the laser diode. Further, the reception time of the light pulse may be determined. For example, the reception time of the light pulse may be determined by detecting at least one of the ascending edge time or the descending edge time of the electrical signal pulse. For example, the ranging apparatus 200 may calculate the TOF by using the pulse reception time information and the pulse transmission time information to determine the distance between the detected object 201 and the ranging apparatus 200. The distance and orientation detected by the ranging apparatus 200 may be used for remote sensing, obstacle avoidance, surveying and mapping, modeling, navigation, etc.

The ranging apparatus may be merely used as an example to explain and describe the structure and the ranging principle of the ranging apparatus. At least one of the first-type ranging apparatus, the second-type ranging apparatus, or the third ranging apparatus in the ranging system may include the above-described ranging apparatus.

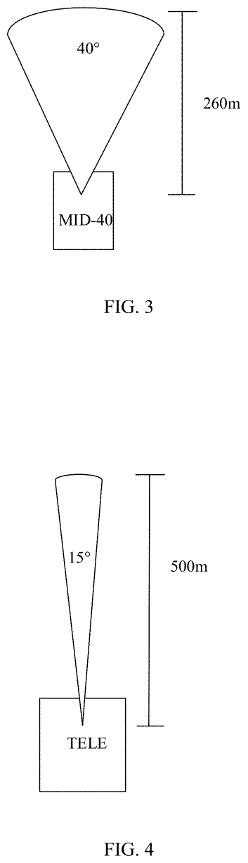

In some embodiment, in the first-type ranging apparatus shown in FIG. 3, a scan FOV of the first-type ranging apparatus is between [30°, 90° ]. In some other embodiments, the scan FOV of the first-type ranging apparatus is between [30°, 50° ]. In some embodiments, a detection distance of the first-type ranging apparatus may be between [200 m, 300 m].

The scanner of the first-type ranging apparatus may include a first optical element and a second optical element, that is light refraction elements. The first optical element and/or the second optical element may include a wedge prism. For example, the first optical element and the second optical element may include prisms with a small diameter. For example, the diameter of the wedge prism may be between [25 mm, 35 mm]. In some embodiments, the first-type ranging apparatus may include a reception and emission lens, which may be referred to as a convergent lens. The reception and emission lens may have a small diameter. For example, the diameter of the reception and emission lens may be between [25 mm, 35 mm].

In some embodiments, each of the first optical element and the second optical element may include a first surface and a second surface that are opposite and not parallel to each other. An included angle between the first surface and the second surface of the first optical element and/or the second optical element may be between [15°, 21°].

The refractive ability of the first optical element and/or the second optical element may be between [7°, 11°]. The refractive ability of the optical element may refer to when the incident light is perpendicular to the light incident surface, a deflection angle of emission light compared to the incident light. A difference of the refractive abilities being smaller than 10° may refer to that when the incident light is perpendicular to the light incident surface, with a same deflection direction of the incident light, a difference between deflection angles may be smaller than 10°, or with different deflection directions of the incident light, an angle of the deflection directions may be smaller than 10°.

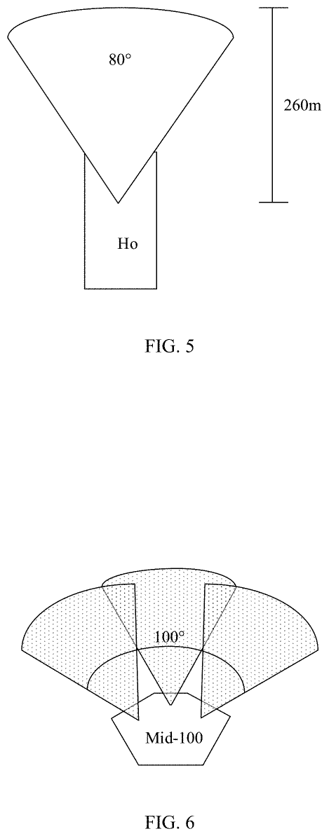

In some embodiments, in the second-type ranging apparatus shown in FIG. 4, a scan FOV of the second-type ranging apparatus is between [10°, 20° ]. In some other embodiments, the scan FOV of the second-type ranging apparatus is between [13°, 18° ]. In some embodiments, a detection distance of the second-type ranging apparatus may be between [400 m, 650 m]. In some other embodiments, the detection distance of the second-type ranging apparatus may be between [500 m, 600 m]. With a large diameter, a collimation lens (i.e., the reception and emission lens or the convergent lens) may receive more energy of a returned wave, and a reception signal of radar may become stronger. As the focal length of the lens increases, a space angle of noise light that can be received by an avalanche photodiode (APD) may decrease, and the noise will decrease. Therefore, the detection distance may increase.

The scanner of the second-type ranging apparatus may include a first optical element and a second optical element, that is light refraction elements. The first optical element and/or the second optical element may include a wedge prism. For example, the first optical element and the second optical element may include prisms with a large diameter. For example, the diameter of the wedge prism may be between [45 mm, 60 mm]. In some embodiments, the second-type ranging apparatus may include a reception and emission lens, which may be referred to as a convergent lens. The reception and emission lens may have a small diameter. For example, the diameter of the reception and emission lens may be between [45 mm, 60 mm]. The detection distance of the first-type ranging apparatus may be 40% to 60% of the detection distance of the second-type ranging apparatus.

In some embodiments, each of the first optical element and the second optical element may include a first surface (a light incident surface) and a second surface (light emission surface) that are opposite and not parallel to each other. An included angle between the first surface and the second surface of the first optical element and/or the second optical element may be between [5°, 9° ].

A refractive ability of the first optical element and/or the second optical element may be between [2°, 5° ]. The refractive ability of the optical element may refer to when the incident light is perpendicular to the light incident surface, a deflection angle of emission light compared to the incident light. A difference of the refractive abilities being smaller than 10° may refer to that when the incident light is perpendicular to the light incident surface, with a same deflection direction of the incident light, a difference between deflection angles may be smaller than 10°, or with different deflection directions of the incident light, an angle of the deflection directions may be smaller than 10°.

In some embodiments, in the third-type ranging apparatus shown in FIG. 5, a horizontal FOV of the third-type ranging apparatus is between [70°, 90° ]. In some other embodiments, the vertical FOV of the third-type ranging apparatus is between [20°, 30° ]. In some embodiments, a detection distance of the third-type ranging apparatus may be between [200 m, 300 m].

In some embodiments, the ranging system may further include a fourth-type ranging apparatus. In some embodiments of the fourth-type ranging apparatus shown in FIG. 6, the fourth-type ranging apparatus includes at least two first-type ranging apparatuses, for example, three first-type ranging apparatuses. Optical axes of neighboring first-type ranging apparatuses of the three first-type ranging apparatuses may include predetermined included angles to cause FOVs of the two neighboring first ranging apparatuses to have an overlapped portion. For example, an included angle between optical axes of the neighboring first-type ranging apparatuses of the three first-type ranging apparatuses may be between [25°, 35° ]. Thus, the three first-type ranging apparatuses 301, 302, and 303 form the fourth-type ranging apparatus with the horizontal FOV from around 95° to 105°. An angle of the overlapped portion of the neighboring first-type ranging apparatuses of the fourth-type ranging apparatus may be between 5° and 15°.

In some embodiments, at least two types of ranging apparatuses in the ranging system may be configured to be arranged at the mobile platform. A total FOV of the ranging system may at least cover 180° of at least a side of the mobile platform. Further, the total FOV of the ranging system may at least cover 180° in the front of the mobile platform. Exemplarily, the total FOV of the ranging system may at least cover 180° in the horizontal direction of the mobile platform.

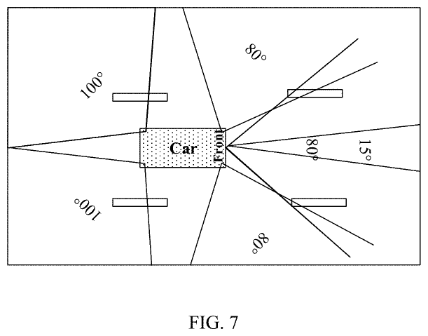

In some embodiments, as shown in FIG. 7, the ranging system includes two fourth-type ranging apparatuses arranged at the rear (e.g., arranged at rear left and rear right of the mobile platform at an interval) of the mobile platform (e.g., a car), three third-type ranging apparatuses arranged at the front of the mobile platform at intervals (e.g., the three third-type ranging apparatuses arranged at the front left, direct front, and front right of the mobile platform at intervals), and a second-type ranging apparatus arranged at front of the mobile platform. The second-type ranging apparatus may be arranged in a central area at the front of the mobile platform to detect a further distance in front of the mobile platform. A front FOV coverage may be high, thus, a density of a point cloud may be high, which may be more beneficial for the perception of the environment. In some embodiments, compared to a scan density of the first-type ranging apparatus, a scan density of the third-type ranging apparatus may be higher. Thus, the cost of the third-type ranging apparatus may be higher than the cost of the first-type ranging apparatus. Therefore, the third ranging apparatus may be arranged at the front of the mobile platform, the fourth-type ranging apparatus formed by a plurality of first-type ranging apparatuses may be arranged at the rear of the mobile platform to consider both scan precision and cost.

Referring again to FIG. 7, a FOV of the second-type ranging apparatus may overlap with a FOV of the third-type ranging apparatuses at the front of the mobile platform, and/or an overlap portion between FOVs of two neighboring third-type ranging apparatuses may be between [5°, 20° ].

In some embodiments, the FOV of the second-type ranging apparatus may overlap with the FOV of the third-type ranging apparatuses at the front of the mobile platform, and/or an overlap portion between the FOVs of the two neighboring third-type ranging apparatuses may be between [5°, 20° ].

In some embodiments, a total FOV of the three third-type ranging apparatuses and the second-type ranging apparatus at the front of the mobile platform may be between [180°, 220° ], and/or a total FOV of the two fourth-type ranging apparatuses at the rear of the mobile platform may be between [180°, 200° ].

The ranging system may detect the FOV with a larger area in front of the mobile platform and detect a further distance.

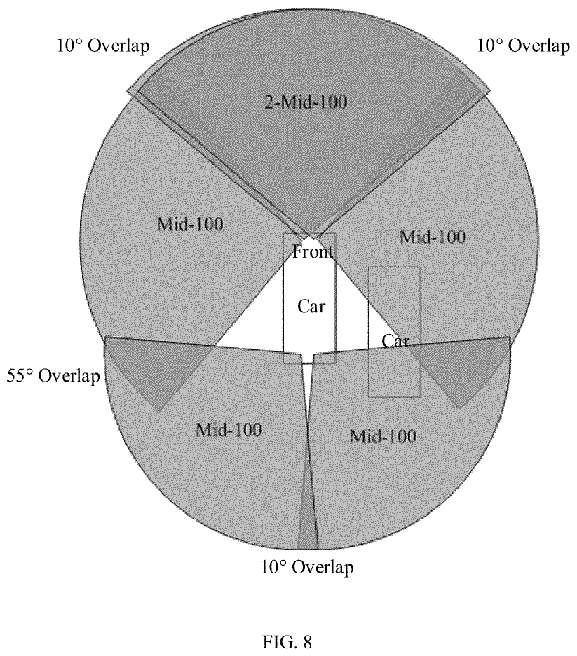

In some embodiments, as shown in FIG. 8, a ranging system includes two fourth-type ranging apparatuses arranged at the front of the mobile platform, two fourth-type ranging apparatuses arranged at the front left and front right of the mobile platform, respectively, and two fourth-type ranging apparatuses arranged at the rear left and rear right of the mobile platform, respectively. The two fourth-type ranging apparatuses at the front of the mobile platform have an overlapped portion.

In some embodiments, the overlapped portion may take 70% to 95% of a FOV of any one of the fourth-type ranging apparatuses to cause the density of point cloud detected in front to be higher. The FOV may be equivalent to a 64-line density.

In some embodiments, a total horizontal FOV of the four fourth-type ranging apparatuses arranged at the front, front left, and front right of the mobile platform may be between [270°, 290° ], and/or a total horizontal FOV of the two fourth-type ranging apparatuses arranged at the rear left and rear right of the mobile platform may be between [180°, 200° ].

In some other embodiments, an angle of the overlapped portion of the two fourth-type ranging apparatuses at the front of the mobile platform may be between [70°, 95° ], and/or an angle of an overlapped portion between the fourth-type ranging apparatus at the front of the mobile platform and the fourth-type ranging apparatus at the front left of the mobile platform may be between [5°, 15° ], and/or an angle of an overlapped portion between the fourth-type ranging apparatus at the front of the mobile platform and the fourth-type ranging apparatus at the front right of the mobile platform may be between [5°, 15° ], and/or an angle of an overlapped portion between the two fourth-type ranging apparatuses at the front left and rear left of the mobile platform may be between [45°, 65° ], and/or an angle of an overlapped portion between the two fourth-type ranging apparatuses at the front right and rear right of the mobile platform may be between [45°, and 65° ].

The above ranging system may cover a FOV of 360° surround the mobile platform, and a small blind zone nearby may be small too. Around 100° of the FOV in front of the mobile platform may be equivalent to the 64-line density. Thus, the density of the point cloud may be higher, and the detection may be more precise.

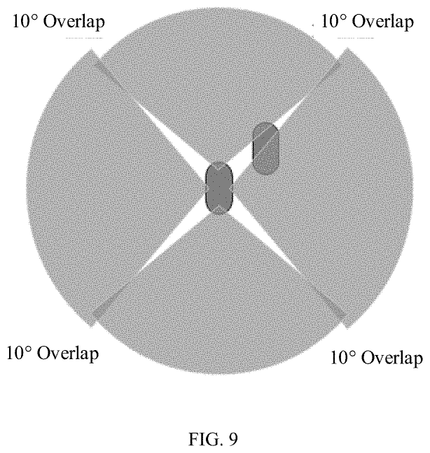

In some embodiments, as shown in FIG. 9, a ranging system includes four fourth-type ranging apparatuses arranged at the front, rear, left side, and right side of the mobile platform. FOVs of neighboring fourth-type ranging apparatuses have an overlapped portion. In some embodiments, the overlapped portion of the FOVs may be between [5°, 15° ], or in another angle range.

In some embodiments, a total FOV of the ranging system may cover 360° of the mobile platform in the horizontal direction. The ranging system may cover the FOV of 360°, and the nearby blind zone may be small too. However, the density of the point cloud may not be enough, thus, the ranging system may be suitable for a mobile platform driving with a low speed.

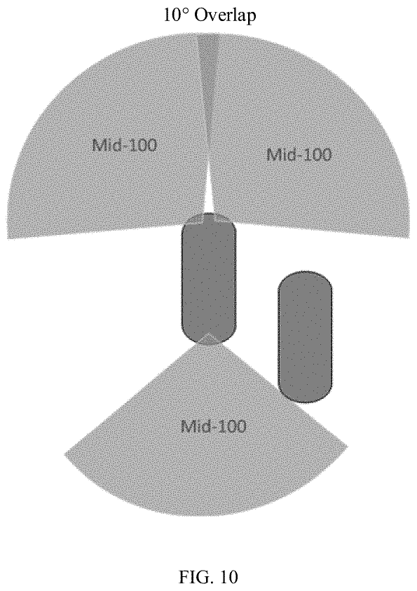

In some embodiments, as shown in FIG. 10, a ranging system includes two fourth-type ranging apparatuses arranged at the front of the mobile platform and one fourth-type ranging apparatus arranged at the rear of the mobile platform. The two fourth-type ranging apparatuses have an overlapped portion. In some embodiments, an angle of the overlapped portion may be between [5°, 15° ].

In some embodiments, a total FOV of the two fourth-type ranging apparatuses at the front of the mobile platform may cover an angle between [185°, 195° ] in front of the mobile platform. Further, a total FOV of the fourth-type ranging apparatus at the rear of the mobile platform may cover an angle between [90°, 110° ] behind the mobile platform.

The ranging system uses a small quantity of ranging apparatuses (e.g., LIDARs). The system is simple and suitable for a scene with a low speed and no requirement for a detection side. However, the point cloud of the system may be not enough, and the detection side may have a blind zone.

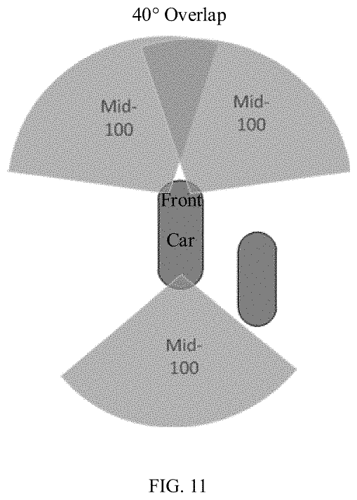

In some embodiments, as shown in FIG. 11, a ranging system includes two fourth-type ranging apparatuses arranged at the front of the mobile platform and a fourth-type ranging apparatus arranged at the rear of the mobile platform. The two fourth-type ranging apparatuses at the front of the mobile platform have an overlapped portion. In some embodiments, an angle of the overlapped portion may be between [15°, 65° ], and/or a total FOV of the two fourth-type ranging apparatuses at the front of the mobile platform may cover an angle of [135°, 185° ] in front of the mobile platform. A total FOV of the fourth-type ranging apparatus at the rear of the mobile platform may cover an angle between [90°, 110° ] behind the mobile platform.

A quantity of ranging apparatuses (e.g., LIDARs) used on the ranging system may be small, and the system may be simple and suitable for a scene with a low speed and no requirement of the detection side. The FOV in the middle may have a high density of the point cloud, which may be beneficial for detection in front of the mobile platform. However, the detection side may have a large blind zone.

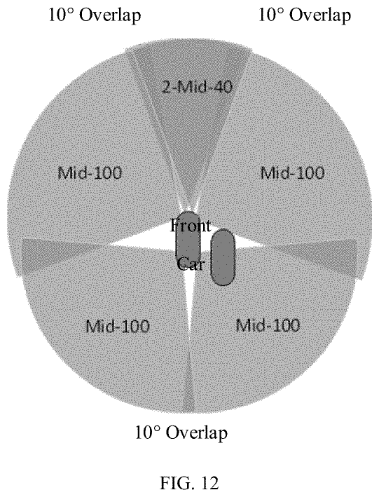

In some embodiments, as shown in FIG. 12, a ranging system includes two fourth-type ranging apparatuses arranged at the front left and front right of the mobile platform and two first-type ranging apparatuses arranged at the front of the mobile platform. Neighboring ranging apparatuses of the two fourth-type ranging apparatuses and the two first-type ranging apparatuses have an overlapped portion.

In some embodiments, the ranging system further includes two fourth-type ranging apparatuses arranged at the rear left and rear right of the mobile platform, respectively. In some embodiments, a total FOV of the ranging system convers 360° of the mobile platform in the horizontal direction.

Further, the two first-type ranging apparatuses at the front of the mobile platform have an overlapped portion. The overlapped portion may take 70% to 95% of the FOV of any one of the two first-type ranging apparatuses. A total horizontal FOV of the two first-type ranging apparatuses arranged at the front of the mobile platform and the two fourth-type ranging apparatuses arranged at the front left and front right of the mobile platform may be between [200°, 240° ]. A total horizontal FOV of the two fourth-type ranging apparatuses arranged at the rear left and rear right of the mobile platform may be between [180°, 200° ].

Further, an angle of the overlapped portion of the FOVs of the two first-type ranging apparatuses at the front of the mobile platform may be between [20°, 35° ]. An angle of the overlapped portion of the FOVs of the first-type ranging apparatus at the front of the mobile platform and the fourth-type ranging apparatus at the front left of the mobile platform may be between [5°, 15° ], and/or an angle of the overlapped portion of the FOVs of the first-type ranging apparatus at the front of the mobile platform and the fourth-type ranging apparatus at the front right of the mobile platform may be between [5°, 15° ], and/or an angle of the overlapped portion of the FOVs of the two fourth-type ranging apparatuses at the front left and the rear left may be between [45°, 65° ]. An angle of the overlapped portion of the FOVs of the two fourth-type ranging apparatuses at the front right and rear right of the mobile platform may be between [45°, 65° ].

The ranging system may cover 360° of the FOV surround the mobile platform. The ranging system may pay more attention to the density of the FOV of the overlapped portion in the front, e.g., 40°, which has a small blind zone. However, many the ranging apparatuses may be included in the ranging system.

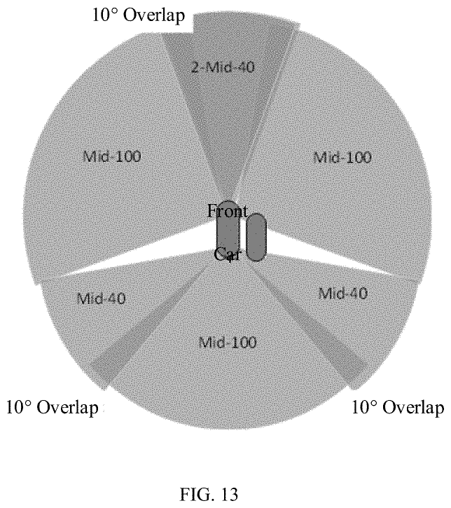

In some embodiments, as shown in FIG. 13, a ranging system includes two fourth-type ranging apparatuses arranged at the front left and front right of the mobile platform and two first-type ranging devices arranged at the front of the mobile platform. Neighboring ranging apparatuses of the two fourth-type ranging apparatuses and the two first-type ranging devices have an overlapped portion.

Further, the ranging system further includes two first-type ranging apparatuses arranged at the rear left and rear right of the mobile platform and a fourth-type ranging apparatus arranged at the rear of the mobile platform.

In some embodiments, a total FOV of the ranging system may cover 360° of the mobile platform in the horizontal direction.

In some embodiments, the two first-type ranging apparatuses at the front of the mobile platform may have an overlapped portion. The overlapped portion may take 70% to 95% of the FOV of any one of the first-type ranging apparatuses. In some embodiments, a total horizontal FOV of the two first-type ranging apparatuses arranged at the front of the mobile platform and the two fourth-type ranging apparatuses arranged at the front left and front right of the mobile platform may be between [200°, 240° ].

Further, a total horizontal FOV of the two first-type ranging apparatuses arranged at the rear left and rear right of the mobile platform and the fourth-type ranging apparatus arranged at the rear of the mobile platform may be between [140°, 180° ].

An angle of the overlapped portion of the FOVs of the two first-type ranging apparatuses at the front of the mobile platform may be between [20°, 35° ], an angle of the overlapped portion of the FOVs of the first-type ranging apparatus at the front of the mobile platform and the fourth-type ranging apparatus arranged at the front left of the mobile platform may be between [5°,15° ], and/or an angle of the overlapped portion of the FOVs of the first-type ranging apparatus arranged at the front of the mobile platform and the fourth-type ranging apparatus arranged the front right of the mobile platform may be between [5°, 15° ], and/or an angle of the overlapped portion of the FOVs of the two fourth-type ranging apparatuses arranged at the front left and the rear left of the mobile platform may be between [45°, 65° ]. In some embodiments, an angle of the overlapped portion of the FOVs of the first-type ranging apparatus arranged at the rear right of the mobile platform and the fourth-type ranging apparatus arranged at the rear of the mobile platform may be between [5°, 15° ], and/or an angle of the overlapped portion of the FOVs of the first-type ranging apparatus arranged at the rear left and the fourth-type ranging apparatus arranged at the rear of the mobile platform may be between [5°, 15° ].

The ranging system of embodiments of the present disclosure may focus on the density of the FOV of the overlapped portion in front of the ranging system, e.g., 40°, and have a small blind zone. However, many ranging apparatuses may be included, thus, the disadvantage may be that many LIDARs may be included.

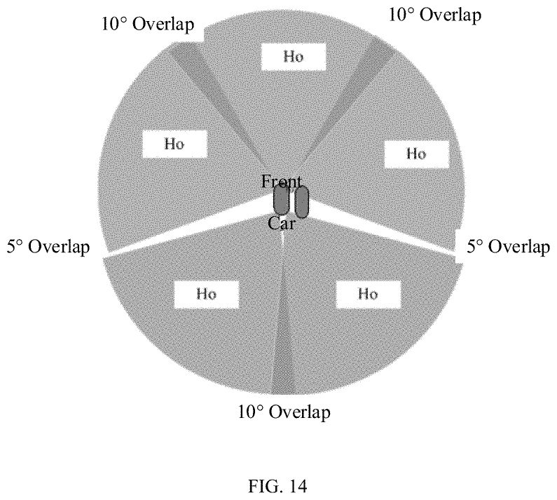

In some embodiments, as shown in FIG. 14, a ranging system includes two third-type ranging apparatuses arranged at the front left and front right of the mobile platform, respectively, and a third-type ranging apparatus arranged at the front of the mobile platform. FOVs of neighboring third-type ranging apparatuses have an overlapped portion.

In some embodiments, the ranging system further includes two third-type ranging apparatuses arranged at the rear left and rear right of the mobile platform. In some embodiments, an angle of an overlapped portion of the FOVs of the two third-type ranging apparatuses arranged at the front left and the rear left of the mobile platform may be between [1°, 10°], and/or an angle of an overlapped portion of the FOVs of the two third-type ranging apparatuses arranged at the front right and rear right of the mobile platform may be between [1°, 10°], and/or an angle of an overlapped portion of the FOVs of two third-type ranging apparatuses arranged at the rear left and rear right may be between [5°, 15° ]. In some embodiments, an angle of an overlapped portion of FOVs of neighboring third-type ranging apparatuses may be between [5°, 15° ]. In some embodiments, a total horizontal FOV of the two third-type ranging apparatuses arranged at the front left and front right of the mobile platform and the third-type ranging apparatus arranged at the front of the mobile platform may be between [210°, 230° ]. In some embodiments, a total horizontal FOV of the two third-type ranging apparatuses arranged at the rear left and rear right of the mobile platform may be between [145°, 155° ].

The above ranging system may cover 360° of the FOV around the mobile platform. However, a large blind zone may be included at a side of the mobile platform.

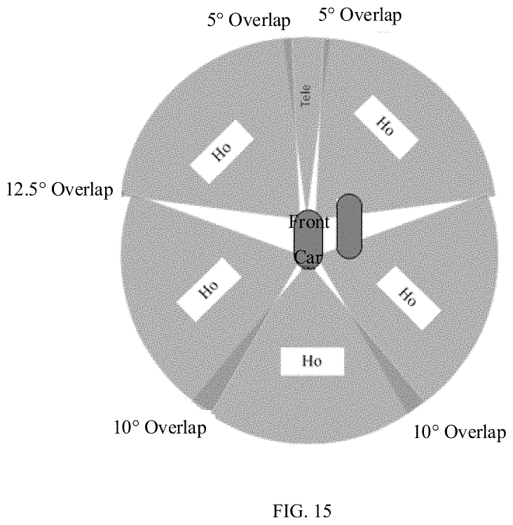

In some embodiments, as shown in FIG. 15, a ranging system includes two third-type ranging apparatuses arranged at the rear left and rear right of the mobile platform, respectively, and a third-type ranging apparatus arranged at the rear of the mobile platform. FOVs of neighboring third-type ranging apparatuses may have an overlapped portion. In some embodiments, the ranging system further includes two third-type ranging apparatuses arranged at the front left and front right of the mobile platform, respectively, and a second-type ranging apparatus arranged at the front of the mobile platform. Neighboring third-type ranging apparatus and second-type ranging apparatus have an overlapped portion.

In some embodiments, an angle of the overlapped portion of the FOVs of the neighboring third-type ranging apparatus and the second-type ranging apparatus may be between [1°, 10° ], and/or an angle of an overlapped portion of FOVs of the third-type ranging apparatus arranged at the front left of the mobile platform and the third-type ranging apparatus arranged at the rear left of the mobile platform may be between [7°, 17° ], and/or an angle of an overlapped portion of FOVs of the third-type ranging apparatus arranged at the front right of the mobile platform and the third-type ranging apparatus arranged at the rear right of the mobile platform may be between [7°, 17° ], and angles of overlapped portions of FOVs of the third-type ranging apparatus arranged at the rear of the mobile platform and two third-type ranging apparatuses at both sides of and neighboring to the third-type ranging apparatus arranged at the rear of the mobile platform may be between [5°, 15° ]. In some embodiments, a total FOV of the ranging system may cover 150° to 180° in front of the mobile platform, and/or a total FOV of the ranging system may cover from 200 to 240 behind the mobile platform.

The above ranging system may cover 360° of the FOV around the mobile platform. The second-type ranging apparatus (15° FOV) for detecting the FOV in front of the mobile platform may have a longer detection distance, which facilitates performing detection on the object that is far away. However, many ranging apparatuses may be included, and the cost may be high.

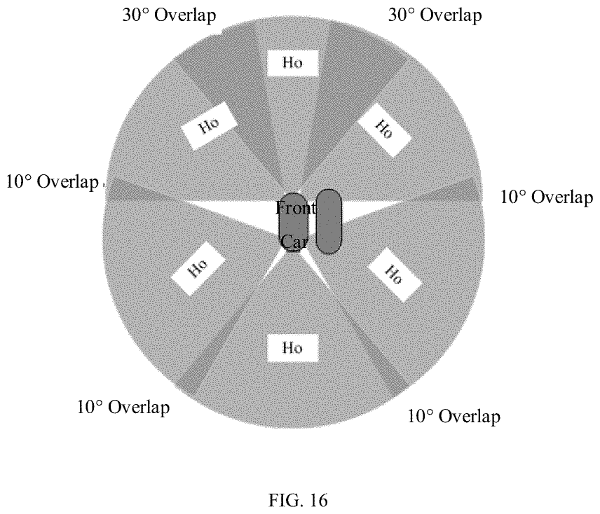

In some embodiments, as shown in FIG. 16, a ranging system includes two third-type ranging apparatuses arranged at the rear left and rear right of the mobile platform, respectively, and a third-type ranging apparatus arranged at the rear of the mobile platform. FOVs of neighboring third-type ranging apparatuses may have an overlapped portion. Further, the ranging system further includes two third-type ranging apparatuses arranged at the front left and front right of the mobile platform, respectively, and a third-type ranging apparatus arranged at the front of the mobile platform. FOVs of neighboring third-type ranging apparatuses have an overlapped portion. In some embodiments, angles of overlapped portions of the third-type ranging apparatus arranged at the front of the mobile platform and the two third-type ranging apparatuses arranged at both sides of and neighboring to the third-type ranging apparatuses may be between [20°, 40° ], and/or an angle of ab overlapped portion of the two third-type ranging apparatus arranged at the front left and rear left may be between [5°, 15° ], and/or an angle of an overlapped portion of the two third-type ranging apparatuses arranged at the front right and rear right of the mobile platform may be between [5°, 15° ]. The ranging system may cover a range from about 170° to 190° in front of the mobile platform and a range from 200° to 240° behind the mobile platform.

The above ranging system may cover 360° of FOV around the mobile platform, and the blind zone may be small. However, many ranging apparatus may be included, and the cost may be high.

In some embodiments, the ranging apparatus of embodiments of the present disclosure may be applied to a mobile platform. The ranging apparatus may be mounted at a platform body of the mobile platform. The mobile platform having the ranging apparatus may perform measurement on the external environment. For example, a distance between the mobile platform and an obstacle may be measured to avoid the obstacle, and 2-dimensional and 3-dimensional surveying and mapping may be performed on the external environment. In some embodiments, the mobile platform may include at least one of an unmanned aerial vehicle (UAV), a vehicle (including a car), a remote vehicle, a ship, a robot, or a camera. When the ranging apparatus is applied to the UAV, the platform body may be a vehicle body of the UAV. When the ranging apparatus is applied to the car, the platform body may be a body of the car. The car may include an auto-pilot car or a semi-auto-pilot car, which is not limited here. When the ranging apparatus is applied to the remote vehicle, the platform body may be the vehicle body of the remote vehicle. When the ranging apparatus is applied to the robot, the platform body may be the robot. When the ranging apparatus is applied to the camera, the platform body may be a camera body.

In summary, the ranging system of the present disclosure may a variety of different ranging apparatuses. these ranging apparatuses enable the ranging system to have more detection methods, which can perform detection in a farther and larger range of the FOV. Sensing and detecting the surrounding environment of the mobile platform during the movement of the mobile platform may realize the detection of a larger area around the mobile platform, reduce the redundancy of the system, and improve reliability of the system. Thus, the real-time effective sensing of the environment may be realized, and the cost may be reduced.

Although exemplary embodiments have been described herein with reference to the accompanying drawings, described exemplary embodiments are merely exemplary, and are not intended to limit the scope of the present disclosure. Those of ordinary skill in the art may make various changes and modifications without departing from the scope and spirit of the present disclosure. All these changes and modifications are intended to be included in the scope of the present invention as claimed in the appended claims.

Those of ordinary skill in the art may be aware that the units and algorithm steps of the examples described in embodiments of the present disclosure may be implemented by electronic hardware or a combination of computer software and electronic hardware. Whether these functions are executed by hardware or software depends on the specific application and design constraint conditions of the technical solution. Those skilled in the art may use different methods for each specific application to implement the described functions, but such implementation should not be considered as going beyond the scope of the present disclosure.

In some embodiments of the present disclosure, the disclosed device and method may be implemented in another manner. For example, device embodiments described above are only illustrative. For example, the division of the units is only a logical functional division, and another division may exist in actual implementation, for example, a plurality of units or components may be combined or integrated into another device, or some features can be ignored or not implemented.

In the specification provided here, a lot of specific details are described. However, embodiments of the present disclosure may be practiced without these specific details. In some embodiments, well-known methods, structures, and technologies are not shown in detail. Thus, the understanding of this specification may not be obscured.

Similarly, to simplify the present disclosure and help understand one or more of the various aspects of the disclosure, in the description of exemplary embodiments of the present disclosure, the various features of the present disclosure may be sometimes grouped together into a single embodiment, a figure, or its description. However, the method of the present disclosure should not be interpreted as reflecting the intention that the claimed present invention requires more features than those explicitly stated in each claim. More precisely, as reflected in the corresponding claims, the point of the invention is that the corresponding technical problems can be solved with features that are less than all the features of a single disclosed embodiment. Therefore, the claims following specific embodiments are thus explicitly incorporated into the specific embodiments. Each claim itself serves as a separate embodiment of the present invention.

Those skilled in the art can understand that in addition to mutual exclusion between the features, all features disclosed in the specification (including the accompanying claims, abstract, and drawings) and all processes or units of any method or device disclosed in this manner can be combined by any combination. Unless expressly stated otherwise, each feature disclosed in this specification (including the accompanying claims, abstract, and drawings) may be replaced by an alternative feature providing the same, equivalent or similar purpose.

In addition, those skilled in the art may understand that although some embodiments described herein include certain features included in other embodiments but not other features, the combination of features of different embodiments means that they are within the scope of the present disclosure and form different embodiments. For example, in the claims, any one of the claimed embodiments may be used in any combination.

Various component embodiments of the present disclosure may be implemented by hardware, or by a software module that runs on one or more processors, or by a combination of the hardware and the software module. Those skilled in the art should understand that a microprocessor or a digital signal processor (DSP) may be used in practice to implement some or all of the functions of some modules according to embodiments of the present disclosure. The present disclosure may be further implemented as a device program (for example, a computer program and a computer program product) for executing a part or all of the methods described here. Such a program for realizing the present disclosure may be stored on a computer-readable medium or may include the forms of one or more signals. Such a signal may be downloaded from an Internet website, or provided in a carrier signal, or provided in any other forms.

The above-mentioned embodiments may be used to describe rather than limit the present disclosure. Those skilled in the art can design alternative embodiments without departing from the scope of the appended claims. In the claims, any reference signs located between parentheses should not be constructed as a limitation to the claims. The present disclosure may be implemented with the support of hardware including several different elements and a suitably programmed computer. In the unit claims listing several devices, several of these devices may be embodied in the same hardware item. The use of the words first, second, and third, etc. do not indicate any order. These words can be interpreted as names.

What is claimed is:

1. A ranging system comprising at least two types of:
a first-type ranging apparatus;
a second-type ranging apparatus, each of the first-type ranging apparatus and the second-type ranging apparatus including:
a ranging device including:
a light source configured to emit a light pulse sequence;
a convergent lens configured to converge a portion of a light pulse reflected by an object to a receiver;
the receiver configured to determine a distance of an object according to the portion of the light pulse; and
a scanner configured to change an emission direction of the light pulse sequence emitted by the light source to scan in a field of view (FOV) and including:
two rotation light refraction elements, each of the two rotation light refraction elements including a light emission surface and a light incident surface that are opposite and not parallel to each other; and
a third-type ranging apparatus including:
a ranging device including:
a light source configured to emit a light pulse sequence; and
a scanner configured to change an emission direction of the light pulse sequence emitted by the light source to scan in a FOV and including:
three rotation light refraction elements, each of the three rotation light refraction elements including a light emission surface and a light incident surface that are opposite and parallel to each other;
wherein:
a FOV of the second-type ranging apparatus is smaller than a FOV of the first-type ranging apparatus; and
a diameter and a focal length of a convergent lens of the second-type ranging apparatus are greater than a diameter and a focal length of a convergent lens of the first-type ranging apparatus, respectively.

2. The ranging system of claim 1, wherein:
at least two types of the first-type ranging apparatus, the second-type ranging apparatus, and the third-type ranging apparatus of the ranging system are configured to be arranged at a mobile platform; and
a total FOV of the ranging system covers at least 180° of one side of the mobile platform.

3. The ranging system of claim 2, wherein the total FOV of the ranging system covers at least 180° in front of the mobile platform.

4. The ranging system of claim 2, wherein:
the mobile platform includes a car; and
the total FOV of the ranging system covers at least 180° in a horizontal direction of the mobile platform.

5. The ranging system of claim 2, further comprising:
a fourth-type ranging apparatus including:
three first-type ranging apparatuses, optical axes of neighboring first-type ranging apparatuses of the three first-type ranging apparatuses having a predetermined angle to cause FOVs of the neighboring first-type ranging apparatuses to have an overlapped portion.

6. The ranging system of claim 2, wherein an angle of the optical axes of neighboring first-type ranging apparatuses of the three first-type ranging apparatuses is between [25°, 35° ].

7. The ranging system of claim 5, further comprising:
two fourth-type ranging apparatuses arranged at a rear of the mobile platform;
three third-type ranging apparatuses arranged at a front of the mobile platform at intervals; and
a second-type ranging apparatus arranged at a front of the mobile platform, the second-type ranging apparatus being arranged at a center area in the front of the mobile platform.

8. The ranging system of claim 7, wherein:
a FOV of the second-type ranging apparatus overlaps with a FOV of one of the three third-type ranging apparatuses at the front; and/or
an overlapped portion of FOVs of neighboring third-type ranging apparatuses is between [5°, 20° ].

9. The ranging system of claim 7, wherein:
a total FOV of the three third-type ranging apparatuses and the second-type ranging apparatus at the front of the mobile platform is between [180°, 220° ]; and/or
a total FOV of the two fourth-type ranging apparatuses at the rear of the mobile platform is between [180°, 200° ].

10. The ranging system of claim 5, further comprising:
two fourth-type ranging apparatuses arranged at a front of the mobile platform, FOVs of the two fourth-type ranging apparatuses having an overlapped portion;
two fourth-type ranging apparatuses arranged at a front left and a front right of the mobile platform;
two fourth-type ranging apparatuses arranged at a rear left and a rear right of the mobile platform.

11. The ranging system of claim 5, further comprising:
four fourth-type ranging apparatuses arranged at a front, a rear, a left side, and a right side of the mobile platform, FOVs of neighboring fourth-type ranging apparatuses of the four fourth-type ranging apparatuses having an overlapped portion.

12. The ranging system of claim 5, further comprising:
two fourth-type ranging apparatuses arranged at a front of the mobile platform, FOVs of the two fourth-type ranging apparatuses having an overlapped portion; and
a fourth-type ranging apparatus arranged at a rear of the mobile platform.

13. The ranging system of claim 5, further comprising:
two fourth-type ranging apparatuses arranged at a front left and a front right of the mobile platform; and
two first-type ranging apparatuses arranged at a front the mobile platform;
wherein FOVs of neighboring ranging apparatuses of the two fourth-type ranging apparatuses and the two first-type ranging apparatuses have an overlapped portion.

14. The ranging system of claim 2, further comprising:
two third-type ranging apparatuses arranged at a front left and a front right of the mobile platform; and
a third-type ranging apparatus arranged at a front of the mobile platform;
wherein FOVs of neighboring third-type ranging apparatuses have an overlapped portion.

15. The ranging system of claim 2, further comprising two third-type ranging apparatuses arranged at a rear left and a rear right of the mobile platform.

16. The ranging system of claim 2, further comprising:
two third-type ranging apparatuses arranged at a rear left and a rear right of the mobile platform; and
a third-type ranging apparatus arranged at a rear of the mobile platform;
wherein FOVs of neighboring third-type ranging apparatuses have an overlapped portion.

17. The ranging system of claim 1, wherein a FOV of the first-type ranging apparatus is between [35°, 45° ].

18. The ranging system of claim 1, wherein a FOV of the second-type ranging apparatus is between [20°, 25° ].

19. The ranging system of claim 1, wherein a detection distance of the first-type ranging apparatus is 40% to 60% of a detection distance of the second-type ranging apparatus.

20. The ranging system of claim 1, wherein a ranging apparatus includes a LIDAR.
